(19) United States
(12) Patent Application Publication
(10) Pub. No.: US 2011/0177415 A1
(43) Pub. Date: Jul. 21, 2011

(54) VOLTAGE-BASED FLUID SENSOR FOR A FUEL CELL STACK ASSEMBLY

(75) Inventors: Michael D. Harrington, Burlington, MA (US); Richard Jonathan Spadaccini, Paimyra, NY (US)

(73) Assignee: UTC POWER CORPORATION, South Windsor, CT (US)

(21) Appl. No.: 13/061,578

(22) PCT Filed: Oct. 6, 2008
(86) PCT No.: PCT/US08/11512

§ 371 Date: Mar. 1, 2011

(51) Int. Cl. H01M 8/04

(52) U.S. Cl. 429/432

(57) ABSTRACT

A fluid detection system and method is disclosed having sensor elements 66 comprising wire leads 68 and electrodes 74 electrically insulated from the stack 16, and positioned such that a measurable voltage is present between the sensor elements 66 only when fluid in water exit manifold space 54 is in contact with both of the electrodes 74. Sensor element 76 may also be utilized in combination with one or both sensor elements 66, and comprises a wire lead 68 operably connected to a pressure plate 60. Because pressure plate 60 is electrically conductive and in electrical communication with stack 16, a voltage measurable between sensor element 76 and sensor element 66 can be used to indicate that fluid is in contact with electrode 74 of sensor element 66. The placement of the electrodes 78, 80 can further indicate a level of fluid or flow of fluid through stack 16. Sensor elements 66 and 76 may communicate with a controller 82, which in response to a measured voltage, can be used to automatically regulate the fluid balance in stack 16 via water management system 88.

### BACKGROUND

The present disclosure relates in general to the management of fluid in fuel cell power plants, and more particularly, to the detection of fluid in the cell stack assembly of a fuel cell power plant.

Fuel cell power plants are well known for converting chemical energy into usable electrical power. Fuel cell power plants usually comprise multiple fuel cells arranged in a repeating fashion to form a cell stack assembly (“CSA”), including internal ports or external manifolds connecting coolant fluid and reactant gas flow passages or channels. Each individual fuel cell in a CSA typically includes a proton exchange membrane (“PEM”) sandwiched between an anode electrode and a cathode electrode to form a membrane electrode assembly (“MEA”). On either side of the MEA are reactant flow field plates that can be of gas impermeable porous construction or can be solid with defined channels formed therein. These plates supply a reactant fuel (e.g. hydrogen) to the anode, and a reactant oxidant (e.g. oxygen or air) to the cathode. The hydrogen electrochemically reacts with a catalyst layer disposed on the anode side of the PEM to produce positively charged hydrogen protons and negatively charged electrons. The anode side of the PEM only allows the hydrogen protons to transfer through the membrane to the cathode side, forcing the electrons to follow an external path through a circuit to power a load before being conducted to the cathode. When the hydrogen protons and electrons eventually come together at a catalyst layer disposed on the cathode side of the PEM, they combine with the oxidant to produce water and thermal energy.

Fuel cell power plants may comprise subsystems for dealing with the product water and thermal energy produced. The electrochemical reaction in a fuel cell is only efficient at certain operating temperatures, and overheating can cause drying out of the PEM, which not only hinders or prevents the electrochemical reaction from occurring but can also lead to physical degradation of the membrane itself. However, excessive moisture in the CSA can also lead to performance degradation when product water formed at the cathode, for example, accumulates and blocks reactants from reaching the PEM surface, thus inhibiting the electrochemical reaction.

In order to deal with the problems of excessive heat, drying, and moisture, various types of systems have been developed in the art for carefully managing the fluid balance in the CSA such that it stays sufficiently cooled and hydrated for maximum stack performance. Regardless of which system is used, the coolant fluid must be uniformly distributed throughout the CSA in order to prevent the formation of thermal gradients and/or to properly humidify the reactants. Consequently, various methods have been employed in the art to verify whether a proper fluid balance is present in the CSA, including monitoring coolant flow and overall fluid levels.

As an example, in systems where fluid collects in a reservoir, overall fluid presence in the CSA can be measured as a function of height of a column of fluid in the reservoir by using a float type sensor. However, such sensors are comprised of mechanical parts that can break down over time, and that are prone to giving false readings when used under frozen conditions. In systems utilizing a pump to generate a vacuum for drawing fluid through a fluid loop, a pressure transducer is often used. For example, a measured pressure drop (delta P) value from a fluid inlet to a fluid outlet can indicate whether a sufficient volume of fluid is being communicated through the stack. However, in situations where a fluid channel becomes blocked due to freezing of the fluid or other obstruction, a reading of delta P will be measured based on the pull of the vacuum against the obstruction, falsely indicating that the fluid is sufficiently present throughout the fluid loop of the stack.

Other prior art systems detect the presence of fluid by using a conductivity sensor in contact with the fluid. Such sensors may comprise two wire leads proximate one another placed in the flow path of the fluid. A primary signal in the form of a voltage is applied to the leads from an external power source, and when fluid comes into contact with both leads, a circuit is completed through the fluid to allow a secondary signal to travel back to a controller or readout device. However, there are problems associated with the use of conductivity sensors. For example, such devices require the generation of a primary signal from either a battery or a wire tap off of the external circuit of the fuel cell power plant, thus increasing the complexity of the system and/or decreasing the amount of available power provided to a primary load. Additionally, requiring a battery or extra hardware for operation of the sensor runs contrary to the goal of automotive applications in making the system as lightweight and efficient as possible.

### SUMMARY

The present disclosure relates to a fluid detection system and method for a fuel cell power plant. A sensor is utilized having at least two sensor elements, each sensor element comprising an electrode. The sensor elements are positioned such that a measurable voltage is present between the electrodes only when fluid in a cell stack assembly is in electrical communication with both of the electrodes. Depending on the position of the electrodes, the sensor elements may be used to confirm fluid levels or may act as fluid flow confirmation detectors, for example.

### BRIEF DESCRIPTION OF THE DRAWINGS

FIG. 1 is a simplified, perspective view of a fuel cell stack assembly.

FIG. 2 is a cross-sectional perspective view of the water exit manifold of FIG. 1, including an embodiment of the present disclosure.

FIG. 3 is a flow chart showing the automated operation of a controller according to an embodiment of the present disclosure.

FIG. 4A is a cross-sectional view of FIG. 1 facing the fuel inlet and fuel outlet side, in which an embodiment of the present disclosure is shown having a plurality of sensor elements.

FIG. 4B is the system of FIG. 4A, showing a tilted orientation of the cell stack assembly.

FIG. 5 is an enlarged view of the top of the CSA of FIG. 1, showing another embodiment of the sensor elements of the present disclosure.

FIG. 6A is a simplified cross-sectional perspective view of an internal manifold system of a CSA.

FIG. 6B is an enlarged view of an internal manifold of FIG. 6A, showing more detailed structure in addition to an embodiment of the present invention.

### DETAILED DESCRIPTION

Described herein is a system and method for detecting fluid in a CSA using a sensor that has sensor elements comprising spaced electrodes positioned such that a measurable voltage is present between the electrodes only when fluid in the CSA is in electrical communication with both electrodes. The invention is predicated in part on the discovery that fluid present in an operating CSA has a different electrical potential at different locations in the CSA, which can produce a voltage detectable by the system and method of the present disclosure. Thus, the system and method disclosed herein does not require a primary signal, such as a voltage or current, to be applied to the electrodes from a source external to the CSA, and therefore does not require the extra hardware and parasitic power draw associated with prior art conductivity sensors. Rather, the CSA is used to generate the primary signal indicating the presence or absence of fluid, which is received by a controller or other device. Because no secondary signal is required for the detection of the fluid, the complexity of the fuel cell power plant system is reduced and its operating efficiency is increased.

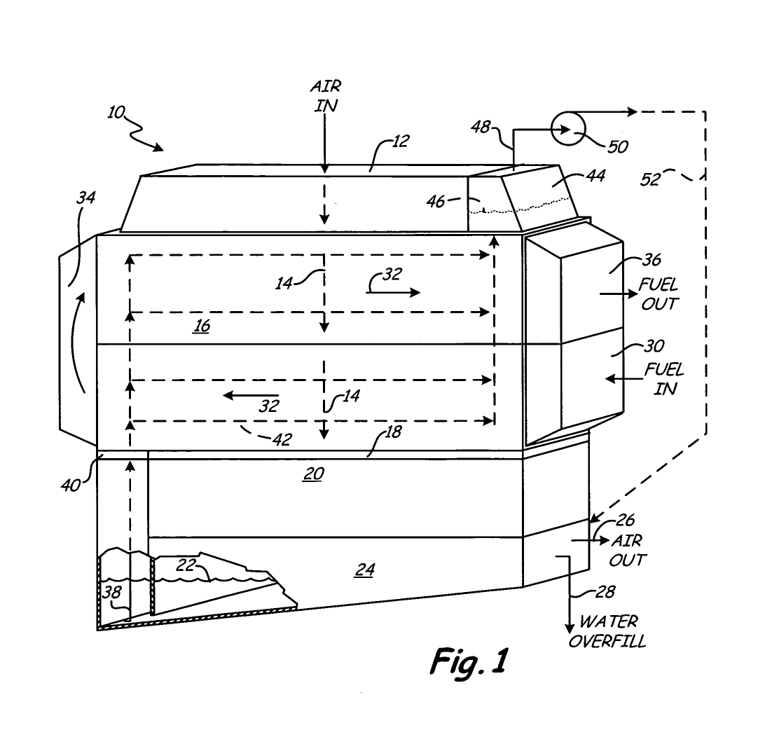

A variety of methods and systems are known in the art for managing the fluid balance in the CSA such that it stays sufficiently cooled and hydrated for maximum stack performance. As an example, some fuel cell power plants use a coolant loop that is physically separate from the fuel cell operations. In such systems, coolant fluid (e.g. water or glycol-based liquid) is actively circulated throughout the coolant loop by a pump, and is used as a heat sink to receive waste heat conducted through the metal elements or barriers separating the fuel cells from the coolant channels comprising the loop. Such systems may humidify the reactant gases prior to supplying the gas to the fuel cells to not only prevent membrane dryout but to also facilitate cooling through evaporative heat transfer. In other systems, such as the one described with reference to FIG. 1, the reactants are humidified internally with the use of water permeable separator plates (not shown) with reactant gas flow fields on one side and water coolant channels (i.e. coolant loop) on the other side. In such systems, pressure differentials between the coolant loop and reactant channels facilitate product water from the cathode side to permeate into the coolant channels, and water to permeate from the coolant channels into the reactant passages on the anode side to humidify the reactants. Regardless of which system is used, the coolant must be uniformly distributed throughout the fuel cell stack in order to prevent the formation of thermal gradients. For internal humidification systems that couple the cooling and humidifying functions, a proper water balance not only ensures sufficient cooling but also the proper humidification of reactants.

FIG. 1 is a simplified, perspective view of CSA 10 having one of many possible reactant flow configurations for air and fuel, and that uses an internal humidification system as described above. Air is provided to air inlet manifold 12 and proceeds through oxidant flow channels 14 (detailed structure not shown) through fuel cell stack (“stack”) 16 and into air exit manifold 18. From air exit manifold 18, hot humidified air travels into condenser 20, which condenses the water vapor in the air into liquid water 22 held in reservoir 24, thereby cooling the air. Cooled air is then expelled at air outlet 26, which may also comprise or be adjacent to water overfill outlet 28.

Fuel provided to fuel inlet manifold 30 travels through fuel flow channels 32 (detailed structure not shown) in stack 16, then through fuel turn manifold 34 and back through more fuel flow channels 32 before exiting into fuel exit manifold 36 for recycling or proper disposal as is known in the art.

Water 22 in reservoir 24 flows through water conduit 38 and into water inlet manifold 40. The water then passes into a series of water channels 42 (detailed structure not shown) distributed throughout stack 16. Water channels 42 may terminate at water exit manifold 44, into which a level of water 46 may be present depending on how far the water has migrated through water channels 42. Attached to water exit manifold 44 is conduit 48 that provides a fluid communication to pump 50. In systems where only evaporative cooling via oxidant flow channels 14 is used for managing the temperature of stack 16, water does not travel through conduit 48 or pump 50. Rather, pump 50 is used to draw a controlled vacuum pressure for ensuring that water will rise through all of the water channels 42 of stack 16, with just enough water entering through water inlet manifold 40 to replace that which evaporated into oxidant flow channels 14. In other systems where stack temperature is managed at least in part with circulating water or other fluid, conduit 48 may act as a water outlet, with pump 50 acting to circulate water through conduit 52 into reservoir 24 and eventually back into water channels 42.

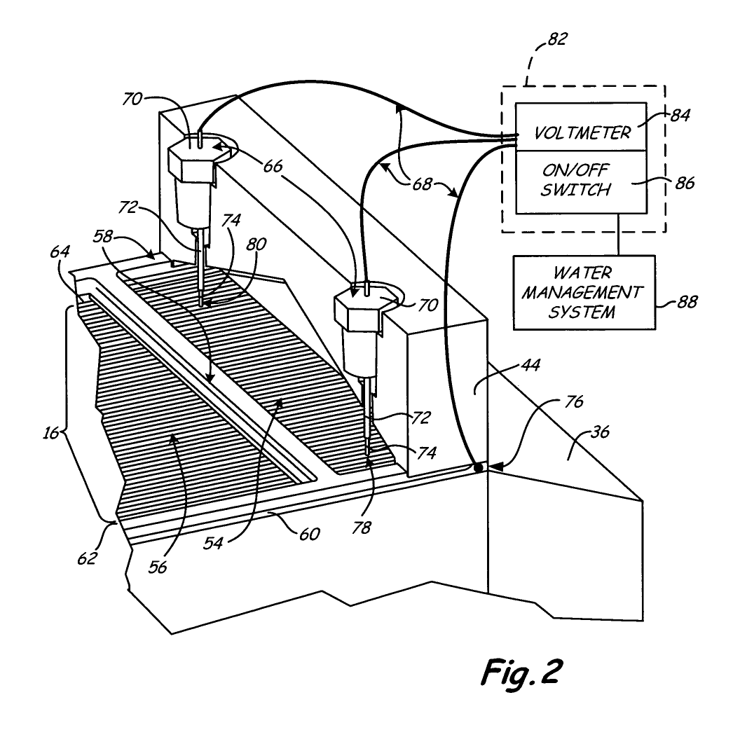

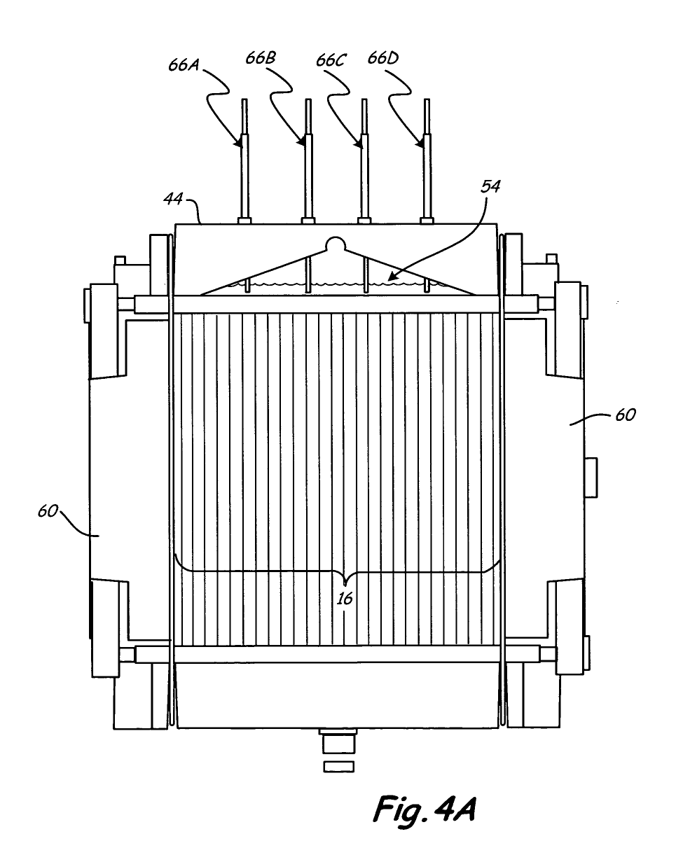

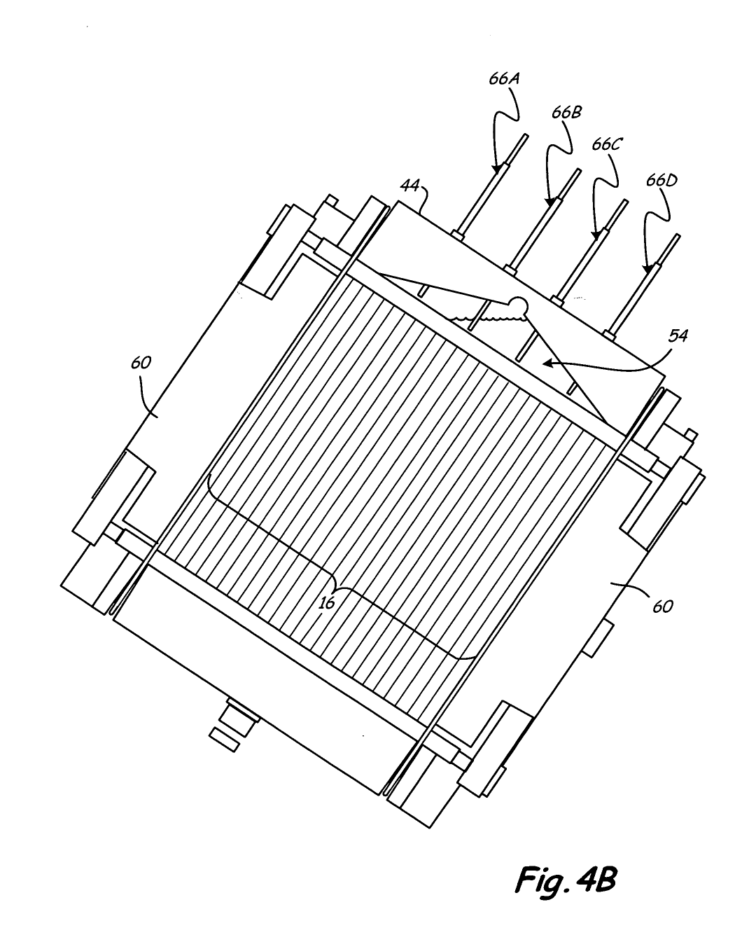

FIG. 2 is a cross-sectional perspective view of water exit manifold 44 of FIG. 1, including an illustration of a preferred embodiment of the present disclosure. As discussed with reference to FIG. 1, water channels 42 eventually terminate in water exit manifold 44. Water exit manifold space 54 is sealed with manifold gaskets 58 to prevent leakage of water into air inlet manifold space 56 and to the external environment. The individual fuel cells of fuel cell stack 16 are shown arranged in an electrical series underneath manifold spaces 54 and 56, and are sandwiched together between pressure plates 60 (both plates shown in FIGS. 4A and 4B) present on opposing sides of stack 16. Due to this arrangement, the electrical potential between anode end 62 to cathode end 64 of stack 16 will increase incrementally by each fuel cell present between anode end 62 and cathode end 64. As an example, a fuel cell stack 16 comprised of 50 fuel cells each producing one volt would produce 50 volts of electrical potential from anode end 62 to cathode end 64, and only 25 volts halfway through stack 16. Stack 16 connected to an external load circuit (not shown) normally forms an electrically closed circuit that is insulated from other components of CSA 10, such as water outlet manifold 44, in order to prevent short circuiting.

However, it was discovered that water in communication with the internal fluid channels of an operating stack carries a current and has an electrical potential measurable using the system and method of the present disclosure. This current and voltage was discovered to be present in water collected in water outlet manifold space 54. This phenomenon can be explained by the electrically conductive elements that comprise the stack 16 components, including water channels 42, combined with the naturally occurring ionic content of water in communication with stack 16. Nonetheless, the extremely high resistance of water with its minimal ionic content keeps the current at a minimal level and thus prevents stack 16 from short circuiting. To date, all cell stack assemblies known in the art comprise liquid, such as water or glycol-based, that is present in communication with an operating stack, such as through coolant channels, water management flow fields, or other internal fluid channels. Furthermore, no known systems electrically insulate such liquids from the fuel cells, and any liquids present in a CSA will naturally have enough ionic content by virtue of contact with metallic components such that a small current can be carried by the liquid. Therefore, it can be appreciated by one skilled in the art that the system and method of the present disclosure for monitoring the presence or absence of fluid in a CSA is generally applicable to any kind of system.

In the embodiment shown in FIG. 2, two sensor elements 66 are shown, each comprising wire lead 68 extending through hexagonal cap fitting 70, through electrically insulative sheath 72, and ending in exposed wire electrode portion 74. Hexagonal cap fitting 70 may be made of plastic or any other suitable material and provides an insulated pathway for wire lead 68 through water exit manifold 44. As an additional alternative, sensor element 76 may also be used, comprising wire lead 68 operably connected to pressure plate 60, in which case pressure plate 60 will act as an electrode. Exposed wire electrodes 74 may be placed at location 78 near anode end 62 of stack 16, location 80 near the cathode end 64 of stack 16, or anywhere in-between. Each exposed wire electrode 74 is positioned to hang in water exit manifold space 54, such that electrodes 74 are not in contact with the components comprising the individual fuel cells in stack 16. When water is not present in water exit manifold space 54, electrodes 74 will be electrically insulated from stack 16 by virtue of the air in manifold space 54 and insulative sheath 72, and therefore no voltage will be measurable between locations 78 and 80 under these conditions. However, when water rises into manifold space 54, it will come into contact with both of the electrodes 74 at positions 78 and 80, and due to the conductivity of the water discussed above, a measurable voltage will be present between electrode positions 78 and 80. This voltage will be present due to the different electrical potentials present at different locations across the operating stack 16 from anode end 62 to cathode end 64, such potentials being present in the water and not just across stack 16 itself.

Sensor element 76 may also be employed, wherein pressure plate 60 is used as an electrode. In this embodiment, due to the conductive nature of pressure plate 60 and its electrical communication with stack 16, a measurable voltage will be present between pressure plate 60 and electrodes 74 positioned anywhere along stack 16 when water in manifold space 54 comes into contact with at least one of those electrodes. Furthermore, the vertical placement of electrodes 74 relative to stack 16 may be adjusted such that a measurable voltage indicates water has risen to a specified level in water exit manifold space 54. For the system of FIG. 1, the presence of water in manifold space 54 would further indicate that water was present throughout water channels 42 in stack 16.

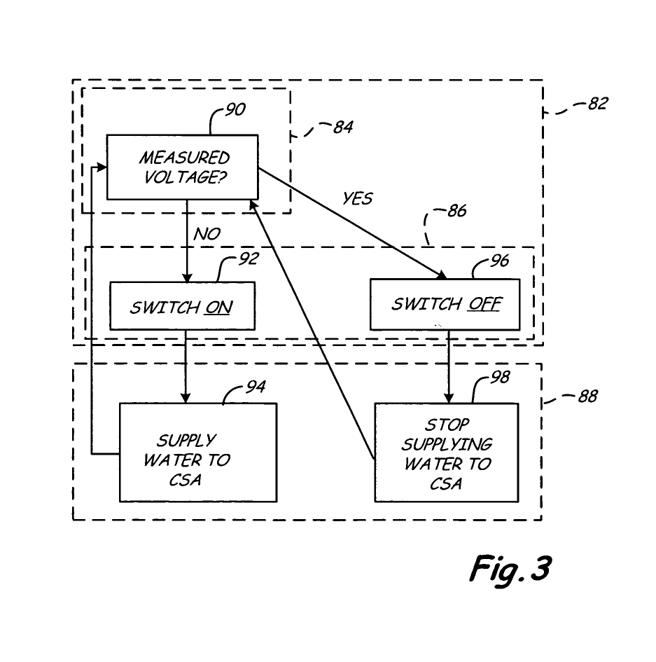

Furthermore, each sensor element 66 and 76 may be connected to a controller 82 as shown. Controller 82 may comprise a voltage detecting device, such as a voltmeter 84. In this embodiment, a display of a measured voltage on voltmeter 84 could signal to a human operator the presence of water in water exit manifold space 54, allowing the operator to act accordingly to adjust the water level in CSA 10. Alternatively, controller 82 may further comprise an on/off switch 86 responsive to voltmeter 84, and operably connected to water management subsystem 88, thus allowing the automated control of water balance in CSA 10 as described with reference to FIG. 3. Water management systems 88 are known in the art and are used to control the amount of water routed to and from CSA 10 for the maintenance of a proper water balance. On/off switches 86 are also known in the art, and for the present disclosure, can be digitally controlled by the simple binary input from voltmeter 84. For example, measured volts versus no measured volts can be set up to correspond to off versus or on, or 1/0 respectively.

FIG. 3 is a flow chart showing the automated operation of controller 82 comprising voltmeter 84 and on/off switch 86 working in conjunction with water management system 88. First, controller 82 monitors whether a voltage has been measured 90 by voltmeter 84. If no voltage is measured, on/off switch 96 is switched to the on state 92 to communicate to water management system 88 to supply water 94 to the CSA. This can be as simple as activating a solenoid valve to open and allow water to flow through from a water source into water channels 42, for example. Controller 82 then continues to monitor whether a voltage has been measured 90 by voltmeter 84. Once a voltage is measured, on/off switch 86 is switched to the off state 96 and communicates to water management system 88 to stop supplying water 98 to the CSA.

Again, controller 82 proceeds to monitor whether a voltage has been measured 90 by voltmeter 84. Water will not be supplied to the CSA again until a measured voltage causes on/off switch 86 to turn on again 92. In this way, a proper water balance is maintained in CSA 10.

FIGS. 4A and 4B are a cross sectional view of FIG. 1 facing fuel inlet 30, fuel outlet 36, and water exit manifold 44 of CSA 10, in which an embodiment of the present disclosure is shown having a plurality of sensor elements 66A, 66B, 66C, and 66D to increase the accuracy of the water level readings, for example, during stack tilt conditions. In FIG. 4A, stack 16 is shown in a normal orientation generally horizontal with the ground, with water present in water exit manifold space 54 such that each sensor element 66A-66D is in contact with the water, enabling a voltage to be measured between any of sensor elements 66A-66D. In FIG. 4B, stack 16 is shown in a tilted orientation, as often occurs in automotive applications when a vehicle drives up a hill or around a steep bank, for example. In the tilted orientation, water in manifold 54 will shift from one side or the other. As an example, FIG. 4B shows the water shifted to the right side of manifold 54 with the tilt of the stack. In such a condition, sensor element 66A will no longer be in contact with the water, and in a system employing only sensor elements 66A and 66D, for example, a voltage would not be measurable between those sensor elements, leading to a false indication that water levels in stack 16 are insufficient. However, using a plurality of sensor elements ensures that a voltage will be measurable between at least two of the sensor elements 66B, 66C or 66D such that a false indication is not produced. Furthermore, this measurable voltage can be used to not only indicate the presence of water in manifold 54, but could also be used as an indicator of stack tilt. For example, lack of a measurable voltage between only sensor elements 66A and 66B could be used indicate the stack is tilted generally to the right, and lack of a measurable voltage between only sensor elements 66C and 66D could be used to indicate the stack is tilted generally to the left. Additionally, the relative degree of tilt could further be indicated. As an example, if a measurable voltage were present between sensor elements 66C and 66D, but not between elements 66B and 66C, this could be used to indicate a dangerous level of tilt, and a warning could be sent to an operator or a control unit to enable correction of the condition.

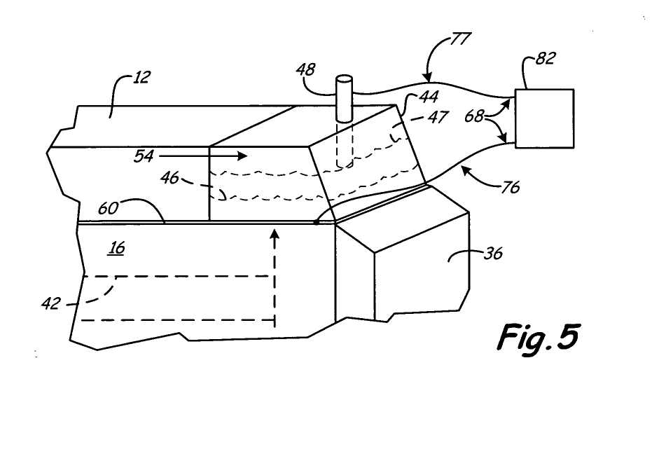

FIG. 5 is an enlarged view of the top of the CSA 10 of FIG. 1, showing another possible embodiment of the sensor elements of the present disclosure. In this embodiment, conduit 48 is comprised of a conductive element, such as a metal, and is positioned to penetrate through water exit manifold 44 and into water exit manifold space 54. Water exit manifold 44 is comprised of an electrically insulative material, such as a plastic, to prevent short circuiting of stack 16. Sensor element 77 comprises a wire lead operably connected to conduit 48, wherein conduit 48 is used as an electrode. Sensor element 76, as described previously, comprises wire lead 68 operably connected to any location on pressure plate 60, in which case pressure plate 60 is used as an electrode. Each sensor element, in turn, may be connected to controller 82 as described in detail with reference to FIG. 2. When water has risen in water exit manifold space 54 to level 46, sensor element 77 will remain electrically insulated from sensor element 76 via air in manifold space 54 and the insulative material comprising water exit manifold 44. However, when water rises to level 47 and comes into contact with conduit 48, a circuit will be completed through the electrically conductive pressure plate 60, the water channels 42 in stack 16, and the water itself, allowing a voltage to be measured between sensor elements 77 and 76. An advantage of this embodiment is that no invasive components are required for the sensor elements, as all of the wire leads may be operably connected to exterior surfaces of the CSA 10 components. One skilled in the art may appreciate that other CSA 10 components could be utilized as an electrode, as long as one of the electrodes utilized is electrically insulated from stack 16 until water or other fluid comes into contact with such electrode to produce a measurable voltage only upon such contact. Furthermore, it may be appreciated that even if one of the sensor elements is not normally electrically insulated from the other sensor element, a measured voltage between the sensor elements may be altered enough by contact with fluid such that the change in measured voltage readings could also be used to indicate the presence or absence of fluid.

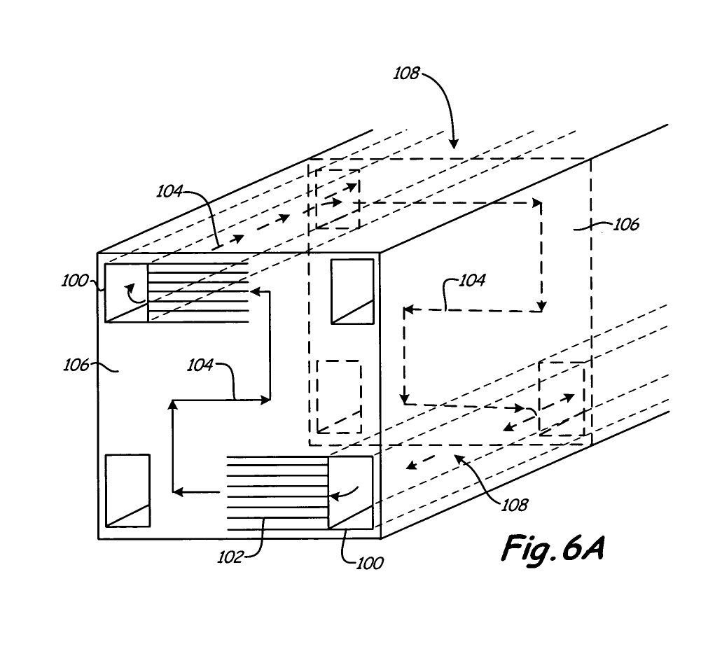

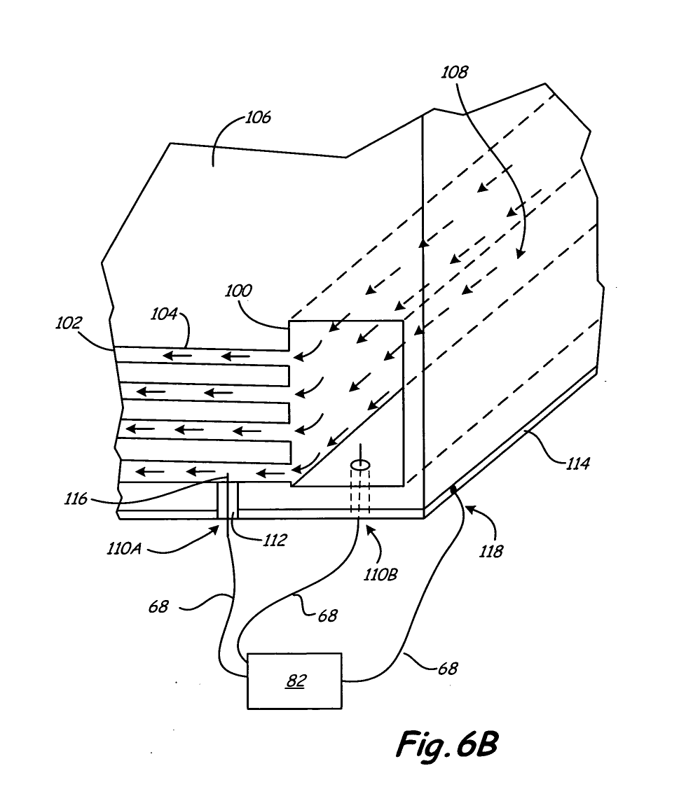

Although the embodiments of the present disclosure thus far have been generally discussed with reference to the system shown in FIG. 1 having external manifolds, the present disclosure may be practiced in internally manifolded systems as well. FIG. 6A is a simplified cross-sectional perspective view of a typical internal manifold system of a CSA having internal manifolds 100 for the transport of fluid through fluid channels 102 as is known in the art. A hypothetical flow of fluid 104, such as water or glycol-based coolant, is also shown, both through water transport plates 106 and through internal manifold spaces 108.

FIG. 6B is an enlarged view of internal manifold 100 of FIG. 6A, showing more detailed structure for fluid channels 102, in addition to an embodiment of the present disclosure. Sensor element 110A is shown in cross section, comprising an insulative housing 112 positioned to penetrate through wall 114, with wire lead 68 terminating in electrode 116 in the flow path of fluid channel 102. Housing 112 may comprise any electrically insulative material as is known in the art, and should be sealed within wall 114 such that leakage of fluid from fluid channel 102 into the external environment cannot occur. Sensor element 110B is shown comprising the same components as sensor element 110A, but instead of electrode 116 positioned in the path of fluid channel 102, it is positioned in the path of internal manifold space 108. Sensor element 118 comprises a wire lead 68 operably connected to wall 114. In this embodiment, wall 114 is an electrically conductive pressure plate; however, wall 114 may comprise any other structural component of the CSA that is electrically conductive and in electrical communication with the stack. When fluid, such as coolant water or glycol-based liquid, comes into contact with either sensor element 110A or 110B, a voltage will be measurable between either 110A or 110B and sensor element 118, thus indicating the flow of fluid through either fluid channels 102 or internal manifold space 108 respectively. Furthermore, sensor elements 110A, 110B and 118 may be operably connected to controller 82, as described with reference to FIG. 2.

Based on the embodiments disclosed, one skilled in the art may appreciate that appropriate sensor elements can be made to work with both internal and external manifold systems, comprising any type of electrically conductive fluid in electrical communication with a fuel cell stack such that a voltage measured between sensor elements indicates the presence of the fluid. It may further be appreciated that depending on the positioning of the electrodes, a measured voltage could be used to indicate the presence of unwanted fluid accumulation within the CSA (such as in reactant manifolds), proper fluid levels or overall fluid balance, proper fluid flow through fluid channels, or otherwise. Although the present invention has been described with reference to preferred embodiments, workers skilled in the art will recognize that changes may be made in form and detail without departing from the spirit and scope of the invention.

1. A fluid detection system for a fuel cell power plant, the system comprising:
an electrochemical cell stack assembly; and
a sensor comprising a first electrode and a second electrode spaced apart, the electrodes positioned to measure a voltage between the electrodes as a function of electrically conductive fluid in the cell stack assembly in contact with at least one of the electrodes.

2. The fluid detection system of claim 1, wherein voltage between the electrodes is a function of whether fluid in the cell stack assembly is in contact with both of the electrodes.

3. (canceled)

4. The fluid detection system of claim 1, wherein the fluid comprises an electrically conductive coolant.

5. The fluid detection system of claim 1, wherein the fluid comprises water.

6. The fluid detection system of claim 1, wherein at least one of the electrodes is positioned to indicate a level of the fluid in the cell stack assembly.

7. The fluid detection system of claim 1, wherein the cell stack assembly further comprises a fluid manifold, and wherein at least one of the electrodes is positioned within the fluid manifold.

8-9. (canceled)

10. The fluid detection system of claim 1, wherein the cell stack assembly further comprises a fluid channel, and wherein at least one of the electrodes is positioned within the fluid channel.

11. (canceled)

12. The fluid detection system of claim 1, and further comprising a controller in communication with the electrodes.

13. The fluid detection system of claim 12, wherein the controller comprises a voltage detection device.

14. The fluid detection system of claim 13, wherein the controller further comprises an on/off switch.

15. The fluid detection system of claim 14, wherein the on/off switch communicates with a fluid management system.

16. The fluid detection system of claim 15, wherein a lack of a measured voltage by the voltage detection device turns the on/off switch to an on state, and wherein the on state signals to the fluid management system to supply a fluid to the cell stack assembly.

17. The fluid detection system of claim 15, wherein a measured voltage by the voltage detection device turns the on/off switch to an off state, and wherein the off state signals to the water management system to stop a supply of a fluid to the cell stack assembly.

18. A fluid detection system for a fuel cell power plant, the system comprising:
an electrochemical cell stack assembly;
a fluid in the cell stack assembly having electrical potential that varies with location within the cell stack assembly;
a first sensing element positioned to contact the fluid;
a second sensing element spaced from the first sensing element; and
a voltage sensor coupled to the first sensing element and the second sensing element for providing an output as a function of voltage between the first sensing element and the second sensing element.

19. The fluid detection system of claim 18, wherein the second sensing element is positioned to contact the fluid.

20. The fluid detection system of claim 18, wherein the first sensing element is positioned to indicate a level of fluid in the cell stack assembly.

21. The fluid detection system of claim 18, wherein the fluid comprises water.

22. The fluid detection system of claim 18, wherein the cell stack assembly further comprises a fluid manifold, and wherein the first sensing element is positioned within the fluid manifold.

23. The fluid detection system of claim 18, wherein the cell stack assembly further comprises a fluid channel, and wherein the first sensing element is positioned within the fluid channel.

24. The fluid detection system of claim 18, further comprising a controller in communication with the first sensing element and the second sensing element.

25-28. (canceled)
